(19) United States
(12) Patent Application Publication
(10) Pub. No.: US 2004/0048164 A1
(43) Pub. Date: Mar. 11, 2004

(54) Electrolyte for lithium-sulfur battery and lithium-sulfur battery

(75) Inventors: Yongju Jung, Suwon-city (KR); Seok Kim, Incheon-city (KR); Jan-Dee Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG SDI CO., LTD. of Republic of Korea

(21) Appl. No.: 10/434,086

(22) Filed: May 9, 2003

(30) Foreign Application Priority Data
Sep. 10, 2002 (KR) 2002-54580

(51) Int. Cl. H01M 10/40; H01M 4/58

(52) U.S. Cl. 429/329; 429/218.1; 429/231.95; 429/224; 429/221; 429/220; 429/231.5; 429/225

(57) ABSTRACT

An electrolyte for a lithium-sulfur battery has organic solvents including dimethoxyethane, dioxolane, and diglyme.

### CROSS-REFERENCE TO RELATED APPLICATIONS

This application is based on application No. 2002-54580 filed in the Korean Intellectual Property Office Patent Office on Sep. 10, 2002, the disclosures of which are incorporated herein by reference.

### BACKGROUND OF THE INVENTION

1. Field of the Invention

The present invention relates to an electrolyte for a lithium-sulfur battery and a lithium-sulfur battery comprising the same, and more particularly, to an electrolyte for a lithium-sulfur battery exhibiting improved high-rate and capacity characteristics and a lithium-sulfur battery comprising the same.

2. Description of the Related Art

The development of portable electronic devices has led to a corresponding increase in the demand for secondary batteries having both a lighter weight and a higher capacity. To satisfy these demands, the most promising approach is a lithium-sulfur battery with a positive electrode made of sulfur-based compounds.

With respect to specific density, the lithium-sulfur battery is the most attractive among the currently developing batteries since lithium has a specific capacity of 3,830 mAh/g, and sulfur has a specific capacity of 1,675 mAh/g. Further, the sulfur-based compounds are less costly than other materials and are environmentally friendly.

Lithium-sulfur batteries use sulfur-based compounds with sulfur-sulfur bonds as a positive active material, and a lithium metal or a carbon-based compound as a negative active material. The carbon-based compound is one which can reversibly intercalate or deintercalate metal ions, such as lithium ions. Upon discharging (i.e., electrochemical reduction), the sulfur-sulfur bonds are cleaved, resulting in a decrease in the oxidation number of sulfur (S). Upon recharging (i.e., electrochemical oxidation), the sulfur-sulfur bonds are re-formed, resulting in an increase in the oxidation number of the S. The electrical energy is stored in the battery as chemical energy during charging and is converted back to electrical energy during discharging.

However, employing a positive electrode based on elemental sulfur in an alkali metal-sulfur battery system has been considered problematic. Although theoretically the reduction of sulfur to an alkali metal-sulfide confers a large specific energy, sulfur is known to be an excellent insulator, and problems using it as an electrode have been noted. Such problems include a very low percentage of utilization and a low cycle life characteristic as a result of the sulfur and lithium sulfide (Li₂S) dissolved and diffused from the positive electrode.

U.S. Pat. No. 6,030,720 (POLYPLUS BATTERY COMPANY) describes a liquid electrolyte solvent including a main solvent having the general formula R₁(CH₂CH₂O)ₙR₂, where n ranges between 2 and 10, R₁ and R₂ are different or identical groups selected from alkyl, alkoxy, substituted alkyl, or substituted alkoxy groups, and also describes a liquid electrolyte solvent including a solvent having at least one of a crown ether, a cryptand, and a donor solvent. Some electrolyte solvents include a donor or an acceptor solvent in addition to the above compound, with an ethoxy repeating unit. The donor solvent is at least one of hexamethylphosphoric triamide, pyridine, N,N-diethylacetamide, N,N-diethylformamide, dimethylsulfoxide, tetramethylurea, N,N-dimethylacetamide, N,N-dimethylformamide, tributylphosphate, trimethylphosphate, N,N,N′,N′-tetraethylsulfamide, tetramethylenediamine, tetramethylpropylenediamine, or pentamethyldiethylenetriamine.

However, higher capacity lithium-sulfur batteries are still required.

### SUMMARY OF THE INVENTION

It is an aspect of the present invention to provide an electrolyte for a lithium-sulfur battery which is capable of providing a lithium-sulfur battery exhibiting high capacity and improved high-rate characteristics.

It is another aspect to provide a lithium-sulfur battery including the electrolyte. These and/or other aspects may be achieved by an electrolyte for a lithium-sulfur battery having an organic solvent including dimethoxyethane, dioxolane, and diglyme, and an electrolytic salt.

To achieve these and/or other aspects, the present invention provides a lithium-sulfur battery having a positive electrode, a negative electrode, and an electrolyte including organic solvents and an electrolytic salt. The organic solvents include dimethoxyethane, dioxolane, and diglyme. The positive electrode includes a positive active material selected from elemental sulfur, a sulfur-based compound, and a mixture thereof. The negative electrode includes a material which is capable of reversibly intercalating or deintercalating lithium ions, i.e., a material which reacts with lithium ions to prepare a lithium-included compound, a lithium metal, and a lithium alloy.

Additional aspects and advantages of the invention will be set forth in part in the description which follows and, in part, will be obvious from the description, or may be learned by practice of the invention.

In the organic solvent, a mixing ratio of dimethoxyethane, dioxolane and diglyme is preferably 10 to 70:5 to 70:10 to 70 volume %. The preferred electrolytic salt is lithium bis(fluoroalkylsulfonyl)imide.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a perspective view showing a lithium-sulfur battery according to Example 1 of the present invention;

FIG. 2 is a graph showing discharge capacities of the cells according to Examples 1 to 5 of the present invention and the cells according to Comparative Examples 4 to 7; and

FIG. 3 is a graph showing mid-voltages of the cells according to Examples 1 to 5 of the present invention and the cells according to Comparative Examples 4 to 7.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

The present invention provides a lithium-sulfur battery exhibiting high capacity and improved high-rate characteristics. Since high capacity and improved high-rate characteristics are achieved from high utilization of sulfur, it is critical to choose a suitable solvent.

When the lithium-sulfur battery is discharged, elemental sulfur (S₈) reduces to generate sulfide (S⁻²) or polysulfide (Sₙ⁻¹, Sₙ⁻², wherein n≧2). Thus, the lithium-sulfur battery uses elemental sulfur, lithium sulfide (Li₂S) or lithium polysulfide (Li₂Sn, n=2, 4, 6, or 8) as a positive active material. The elemental sulfur has low polarity, and the lithium sulfide or lithium polysulfide has high polarity and is an ionic compound. The lithium sulfide is presented in an organic solvent in a precipitated state, and the lithium polysulfide is presented in a dissolved state.

The choice of organic solvents used in an electrolyte is critical for active electrochemical reaction, because the materials used as the positive active material have different physical properties from each other.

In the present invention, the organic solvent uses dimethoxyethane, dioxolane, and diglyme in a desired mixing ratio to provide lithium-sulfur batteries exhibiting a high capacity and improved high-rate characteristics. The mixing ratio of dimethoxyethane, dioxolane, and diglyme is preferably 10 to 70 volume %:5 to 70 volume %: 10 to 70 volume %; more preferably 10 to 65 volume %:5 to 50 volume %:20 to 70 volume %; and most preferably 10 to 65 volume %:10 to 40 volume %:20 to 70 volume %.

Dimethoxyethane dissolves a large amount of polysulfide. If the amount of dimethoxyethane is less than 10 volume %, the amount of polysulfide dissolved decreases, reducing capacity. If the amount of dimethoxyethane is more than 70 volume %, the ionic conductivity of the resulting electrolyte decreases, reducing mid-voltage. The terminology “mid-voltage” is defined as the voltage wherein the capacity is half of the maximum capacity on the discharge curve.

Diglyme dissolves a large amount of polysulfide and helps to improve high-rate characteristics of the battery. If the amount of diglyme is less than 10 volume %, the amount of polysulfide dissolved decreases, reducing capacity and deteriorating high-rate characteristics. If the amount of diglyme is more than 70 volume %, the viscosity of the resulting electrolyte detrimentally increases.

Dioxolane acts to generate a polymer on a surface of lithium during charge and discharge to protect the lithium. If the amount of dioxolane is less than 5 volume %, it is difficult to effectively protect the lithium, and if the amount of dioxolane is more than 70 volume %, the capacity decreases.

In addition, the organic solvent includes at least one weak polar solvent such as xylene, tetrahydrofurane, 2-methyltetrahydrofurane, 2,5-dimethyltetrahydrofurane, diethyl carbonate, dimethyl carbonate, toluene, dimethyl ether, diethyl ether, or tetraglyme; at least one strong polar solvent such as hexamethyl phosphoric triamide, gamma-butyrolactone, acetonitrile, ethylene carbonate, propylene carbonate, N-methyl pyrrolidone, 3-methyl-2-oxazolidone, dimethyl formamide, sulforane, dimethyl acetamide, dimethyl sulfoxide, dimethyl sulfate, ethylene glycol diacetate, dimethyl sulfide, or ethylene glycol sulfide; and at least one lithium-protection solvent such as tetrahydrofurane, ethylene oxide, 3,5-dimethyl isoxasole, 2,5-diemethyl furane, furane, dioxane, 4-methyldioxolane.

The electrolytic salt includes a salt having a lithium cation (hereinafter referred to as “lithium cation salt”), a salt having an organic cation (hereinafter referred to as “organic cation salt’), or a mixture thereof. The content of the salt is preferably 3 to 30 weight %. If a mixture of the lithium cation salt and the organic cation salt are used, the mixing ratio can be suitably controlled.

While others may be used, examples of the lithium cation salt may be lithium bis(fluoroalkylsulfonyl)imide, lithium triflate, and LiPF₆. The lithium bis(fluoroalkylsulfonyl)imide may be lithium bis(trifluoromethylsulfonyl)imide (LiN(CF₃SO₂)₂), lithium bis(perfluoroethylsulfonyl)imide(LiN(C₂F₅SO₂)₂) and a mixture thereof. Most preferred are lithium bis(fluoroalkylsulfonyl)imide such as lithium bis(trifluoromethylsulfide)imide (LiN(CF₃SO₂)₂), lithium bis(perfluoroethylsulfonyl)imide (LiN(C₂F₅SO₂)₂), and a mixture thereof.

The organic cation salt is a salt having organic cations rather than lithium cations. The organic cation salt has a low vapor pressure and a high flash point, so that it is non-combustible, improving the stability of the battery The organic cation salt has a lack of corrosiveness and a capability of being processed in a film form, which is mechanically stable. According to the embodiments of the invention, the salt may be present in a liquid state at a broad range of temperatures, and particularly at a working temperature, so that the salt may used as an electrolyte. The salt is preferably present in a liquid state at a temperature of 100° C. or lower, more preferably at 50° C. or lower, and most preferably at 25° C. or lower. However, it is understood that other working temperatures are possible depending on the application.

While others may be used, the organic cation of the salt is typically a cation of heterocyclic compounds. The heteroatom of the heterocyclic compound is selected from N, O, or S, or a combination thereof. The number of heteroatoms is from 1 to 4, and preferably 1 or 2. Examples of the cation of the heterocyclic compound include, but are not limited to, one selected from the group consisting of pyridinium, pyridazinium, pyrimidinium, pyrazinium, imidazolium, pyrazolium, thiazolium, oxazolium, and triazolium, or substitutes thereof. Preferably, the organic cation includes a cation of an imidazolium compound such as 1-ethyl-3-methylimidazolium (EMI), 1,2-dimethyl-3-propylimidazolium (DMPI), 1-butyl-3-methylimidazolium (BMI), and so on.

The anion to be linked with the cation is at least one selected from the group consisting of bis(perfluoroethylsulfonyl)imide (N(C₂F₅SO₂)₂⁻, Beti), bis(trifluoromethylsulfonyl)imide (N(CF₃SO₂)₂⁻, Im), tris(trifluoromethylsulfonyl)methide (C(CF₃SO₂)₂⁻, Me), trifluoromethane sulfonimide, trifluoromethylsulfonimide, trifluoromethylsulfonate, AsF₉⁻, ClO₄⁻, PF₆⁻, and BF₄⁻.

According to one embodiment of the present invention, the electrolyte includes organic solvents including dimethyoxyethane, dioxolane and diglyme; lithium cation salts selected from the group consisting of LiN(CF₃SO₂)₂, LiN(C₂F₃SO₂)₂ and a mixture thereof; and organic cation salts selected from the group consisting of 1-ethyl-3-methylimidazolium, bis(perfluoroethylsulfonyl)imide (EMIBeti), 1-butyl-3-methylimidazolium hexafluorophosphate (BMIPF₆), and a mixture thereof.

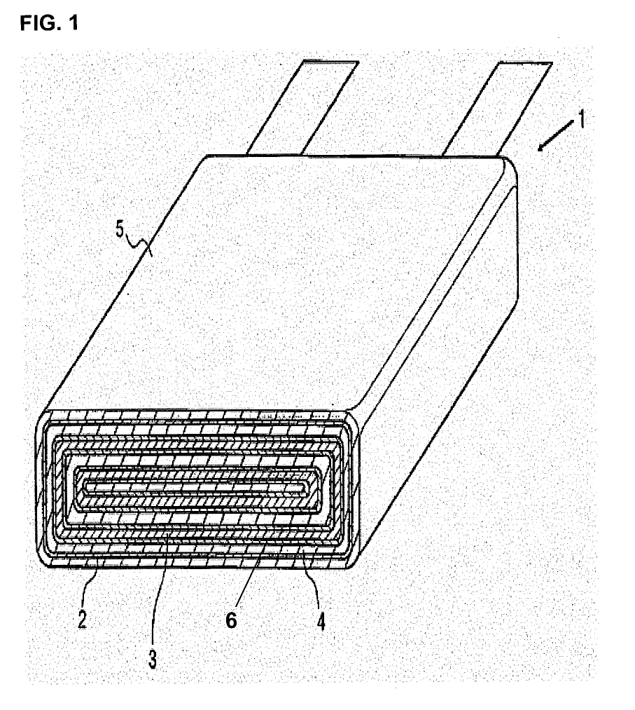

The lithium-sulfur battery 1 according to one embodiment of the present invention includes a can 5 containing a positive electrode 3, a negative electrode 4, and a separator 2 interposed between the positive electrode 3 and the negative electrode 4, as shown in FIG. 1. An electrolyte 6 of the present invention is also disposed between the positive electrode 3 and the negative electrode 4.

The positive electrode 3 of the present invention includes elemental sulfur, or sulfur-based compounds for a positive active material. The sulfur-based compounds are selected from the group consisting of Li₂Sₙ (wherein n≧1), Li₂Sₙ (wherein n≧1) dissolved in a catholyte, an organosulfur compound, and a carbon-sulfur polymer ((C₂Sₓ)ₙ: wherein x=2.5˜50, n≧2).

According to an additional embodiment, the positive electrode 3 may optionally include at least one additive selected from the group consisting of a transition metal, a Group IIIA element, a Group IVA element, a sulfur compound thereof, and alloys thereof. The transition metal is preferably, but not limited to, at least one selected from the group consisting of Sc, Ti, V, Cr, Mn, Fe, Co, Ni, Cu, Zn, Y, Zr, Nb, Mo, Tc, Ru, Rh, Pd, Ag, Cd, Ta, W, Re, Os, Ir, Pt, Au, and Hg. The Group IIIA elements preferably include Al, Ga, In, and Tl, and the group IVA elements preferably include Si, Ge, Sn, and Pb.

According to further embodiments of the present invention, the positive electrode 3 further includes electrically conductive materials that facilitate the movement of the electrons within the positive electrode. Examples of the conductive materials include, but are not limited to, a conductive material such as graphite- or carbon-based materials, or a conductive polymer. The graphite-based material includes KS 6 (manufactured by TIMCAL COMPANY), the carbon-based material includes SUPER P (manufactured by MMM COMPANY), ketjen black, denka black, acetylene black, carbon black, and the like. Examples of the conductive polymer include, but are not limited to, polyaniline, polythiophene, polyacetylene, polypyrrole, and the like. The conductive material may be used singularly or as a mixture of two or more of the above conductive materials, according to embodiments of the invention.

The positive active material is adhered on a current collector via a binder. The binder is added to enhance the adherence of the positive active material to the current collector. Examples of the binder include poly(vinyl acetate), poly vinyl alcohol, polyethylene oxide, polyvinyl pyrrolidone, alkylated polyethylene oxide, cross-linked polyethylene oxide, polyvinyl ether, poly(methyl methacrylate), polyvinylidene fluoride, a copolymer of polyhexafluoro propylene and polyvinylidene fluoride (marketed under the name KYNAR), poly(ethyl acrylate), polytetrafluoro ethylene, polyvinyl chloride, polyacrylonitrile, polyvinylpyridine, polystyrene, and derivatives, blends, and copolymers thereof.

A positive electrode preparation of the present invention is illustrated below. A binder is dissolved in a solvent, and a conductive material is distributed therein to prepare a dispersion solution. The solvent may be used so long as it homogeneously disperses a positive active material, the binder, and the conductive material. Useful solvents include, but are not limited to, acetonitrile, methanol, ethanol, tetrahydrofuran, water, isopropyl alcohol, dimethyl formamide, and the like.

A positive active material and an optional additive are homogeneously dispersed in the dispersion solution to prepare a positive active material composition, e.g., in the form of slurry. The amounts of the solvent, the positive active material, the binder, the conductive material, and the optional additive are not critical, but must be sufficient to provide a suitable viscosity such that the composition can easily be coated.

The composition is coated onto a current collector, and the coated collector is vacuum dried to prepare a positive electrode. The composition is coated to a predetermined thickness, depending on the viscosity of the slurry and the thickness of the positive electrode to be prepared. Examples of the current collector include, but are not limited to, a conductive material such as stainless steel, aluminum, copper, or titanium. It is generally preferable to use a carbon-coated aluminum current collector. The carbon-coated aluminum current collector has excellent adhesive properties for adhering to the active materials, shows a lower contact resistance, and shows a better resistance to corrosion caused by the polysulfide as compared to an uncoated aluminum current collector.

The negative electrode 1 of the lithium-sulfur battery 1 includes a negative active material selected from materials in which lithium intercalation reversibly occurs, a material which reacts with lithium ions to form a lithium-containing compound, a lithium metal, or a lithium alloy.

The materials in which lithium intercalation reversibly occurs are carbon-based compounds. Any carbon-based compound may be used as long as it is capable of intercalating and deintercalating lithium ions. Examples of such carbon material include crystalline carbon, amorphous carbon, or a mixture thereof.

Examples of the material that reacts with lithium ions to form a lithium-containing compound include, but are not limited to, tin oxide (SnO₂), titanium nitrate, and Si. The lithium alloy includes an alloy of lithium and a metal selected from Na, K, Rb, Cs, Fr, Be, Mg, Ca, Sr, Ba, Ra, Al, or Sn.

The negative electrode may include an inorganic protective layer, an organic protective layer, or a mixture thereof, on a surface of lithium metal. The inorganic protective layer includes Mg, Al, B, C, Sn, Pb, Cd, Si, In, Ga, lithium silicate, lithium borate, lithium phosphate, lithium phosphoronitride, lithium silicosulfide, lithium borosulfide, lithium aluminosulfide, or lithium phosphosulfide. The organic protective layer includes a conductive monomer, oligomer, or polymer selected from poly(p-phenylene), polyacetylene, poly(p-phenylene vinylene), polyaniline, polypyrroloe, polythiophene, poly(2,5-ethylene vinylene), acetylene, poly(perinaphthalene), polyacene, or poly(naphthalene-2,6-di-yl).

In addition, during charging and discharging of the lithium-sulfur battery, the positive active material (active sulfur) converts to an inactive material (inactive sulfur), which can be attached to the surface of the negative electrode. The inactive sulfur, as used herein, refers to sulfur that has no activity upon repeated electrochemical and chemical reactions so it cannot participate in an electrochemical reaction of the positive electrode. The inactive sulfur on the surface of the negative electrode acts as a protective layer of the lithium negative electrode. Accordingly, inactive sulfur, for example lithium sulfide, on the surface of the negative electrode can be used in the negative electrode.

Porosity of the electrode is a very important factor in determining the amount of impregnation of an electrolyte. If the porosity is very low, discharging occurs locally, which causes unduly concentrated lithium polysulfide and makes precipitation easy, which decreases the sulfur utilization. Meanwhile, if the porosity is very high, the slurry density becomes low so that it is difficult to prepare a battery with a high capacity. Thus, the porosity of the positive electrode according to an embodiment of the invention is at least 5% of the volume of the total positive electrode, preferably at least 10%, and more preferably 15 to 50%.

According to additional embodiments of the invention, a polymer layer of polyethylene or polypropylene, or a multi-layer thereof, is used as a separator between the positive electrode and the negative electrode.

Hereinafter, the present invention will be explained in detail with reference to specific examples. These specific examples, however, should not in any sense be interpreted as limiting the scope of the present invention and equivalents thereof.

### EXAMPLE 1

65 wt % of elemental sulfur (S₈), 15 wt % of a SUPER P conductive material, and 20 wt % of a poly(vinyl acetate) binder were mixed in an acetonitrile solvent to prepare a positive active material slurry. The slurry was coated on a carbon-coated Al current collector with a porosity of approximately 40% and dried for at least 12 hours under vacuum to produce a positive electrode with a current density of 1.85 mAh/cm² and a size of 25×50 mm². Using the positive electrode, a lithium metal negative electrode, and an electrolyte, a lithium-sulfur cell was fabricated. As the electrolyte, 1 M LiN(CF₃SO₂)₂ in a mixed solvent of dimethoxyethane, dioxolane, and diglyme (14:65:21 volume ratio) was used.

### EXAMPLE 2

A lithium-sulfur cell was fabricated by the same procedure as in Example 1, except that 1 M LiN(CF₃SO₂)₂ in a mixed solvent of dimethoxyethane, dioxolane, and diglyme (14:25:61 volume ratio) was used.

### EXAMPLE 3

A lithium-sulfur cell was fabricated by the same procedure as in Example 1, except that 1 M LiN(CF₃SO₂)₂ in a mixed solvent of dimethoxyethane, dioxolane and diglyme (21:65:14 volume ratio) was used.

### EXAMPLE 4

A lithium-sulfur cell was fabricated by the same procedure as in Example 1, except that 1 M LiN(CF₃SO₂)₂ in a mixed solvent of dimethoxyethane, dioxolane, and diglyme (28:45:27 volume ratio) was used.

### EXAMPLE 5

A lithium-sulfur cell was fabricated by the same procedure as in Example 1, except that 1 M LiN(CF₃SO₂)₂ in a mixed solvent of dimethoxyethane, dioxolane, and diglyme (61:25:14 volume ratio) was used.

### COMPARATIVE EXAMPLE 1

A lithium-sulfur cell was fabricated by the same procedure as in Example 1, except that 1 M LiN(CF₃SO₂)₂ in a mixed solvent of dimethoxyethane and diglyme (90:10 volume ratio) was used.

### COMPARATIVE EXAMPLE 2

A lithium-sulfur cell was fabricated by the same procedure as in Example 1, except that 1 M LiN(CF₃SO₂)₂ in a mixed solvent of dimethoxyethane, dioxolane, and dimethylsulfoxide (40:40:20 volume ratio) was used.

### COMPARATIVE EXAMPLE 3

A lithium-sulfur cell was fabricated by the same procedure as in Example 1, except that 1 M LiN(CF₃SO₂)₂ in a mixed solvent of dimethoxyethane, dioxolane, sulforane, and dimethylsulfoxide (60:20:10:10 volume ratio) was used.

### COMPARATIVE EXAMPLE 4

A lithium-sulfur cell was fabricated by the same procedure as in Example 1, except that 1 M LiN(CF₃SO₂)₂ in a mixed solvent of dioxolane and diglyme (85:15 volume ratio) was used.

### COMPARATIVE EXAMPLE 5

A lithium-sulfur cell was fabricated by the same procedure as in Example 1, except that 1M LiN(CF₃SO₂)₂ in a mixed solvent of dioxolane and diglyme (5:95 volume ratio) was used.

### COMPARATIVE EXAMPLE 6

A lithium-sulfur cell was fabricated by the same procedure as in Example 1, except that 1M LiN(CF₃SO₂)₂ in a mixed solvent of dimethoxyethane and dioxolane (15:85 volume ratio) was used.

### COMPARATIVE EXAMPLE 7

A lithium-sulfur cell was fabricated by the same procedure as in Example 1, except that 1M LiN(CF₃SO₂)₂ in a mixed solvent of dimethoxyethane and dioxolane (95:5 volume ratio) was used.

### COMPARATIVE EXAMPLE 8

A lithium-sulfur cell was fabricated by the same procedure as in Example 1, except that 1M LiN(CF₃SO₂)₂ in a mixed solvent of dimethoxyethane and dioxolane (80:20 volume ratio) was used.

### COMPARATIVE EXAMPLE 9

A lithium-sulfur cell was fabricated by the same procedure as in Example 1, except that 1M LiN(CF₃SO₂)₂ in a solvent of dimethoxyethane was used.

### COMPARATIVE EXAMPLE 10

A lithium-sulfur cell was fabricated by the same procedure as in Example 1, except that 1M LiN(CF₃SO₂)₂ in a solvent of 1,3-dioxolane was used.

### COMPARATIVE EXAMPLE 11

A lithium-sulfur cell was fabricated by the same procedure as in Example 1, except that 1M LiN(CF₃SO₂)₂ in a solvent of diglyme was used.

The lithium-sulfur cells according to Examples 1 to 5 and Comparative Examples 1 11 were evaluated using the charge and discharge protocol. The 1^{st} through 5^{th} discharge cycles, which corresponded to a formation process, were set to constant current densities of 0.2, 0.2, 0.4, 1, and 2 mA/cm², respectively. The charge current densities were 1 mA/cm². The cut-off voltages at charge and discharge were respectively 2.8 and 1.5 V. When a shuttle phenomenon occurred in which an increase of voltage stopped, the charge was performed at a 110% charge amount based on the nominal capacity. 100% sulfur utilization was considered to be 837.5 mAh/g of capacity.

As stated, the 1st to 5th cycles were considered to be a formation step. Thus, a substantial charge and discharge cycle result was obtained from the 6^{th} cycle, and the cycle life test was started at the 6th cycle so that the 6^{th} cycle was considered to be a cycle life test 1^{st} cycle. In the cycle life test, the discharge current density was 1 mA/cm² and the charge current density was 0.4 mA/cm².

The discharge capacity and mid-voltage at 5^{th} discharge of the cells according to Examples 1 to 5 and Comparative Examples 1 to 11 are shown in Table 1.

TABLE 1

| | | Discharge | Mid- |
|---|---|---|---|
| | | capacity | voltage |
| | Solvent (volume ratio) | (mAh) | (V) |
| Example 1 | Dimethoxyethane/1,3-dioxolane/ | 22.2 | 1.92 |
| | diglyme (0.14/0.65/0.21) | | |
| Example 2 | Dimethoxyethane/1,3-dioxolane/ | 25.2 | 1.98 |
| | diglyme (0.14/0.25/0.61) | | |
| Example 3 | Dimethoxyethane/1,3-dioxolane/ | 21.7 | 1.92 |
| | diglyme (0.14/0.25/0.61) | | |
| Example 4 | Dimethoxyethane/1,3-dioxolane/ | 23.6 | 1.97 |
| | diglyme (0.61/0.25/0.14) | | |
| Example 5 | Dimethoxyethane/1,3-dioxolane/ | 24.5 | 1.92 |
| | diglyme (0.61/0.25/0.14) | | |
| Comparative | Dimethoxyethane/ | 19.5 | 1.83 |
| Example 1 | diglyme (0.9/0/1) | | |
| Comparative | Dimethoxyethane/1,3- | 18.5 | 1.84 |
| Example 2 | diglymeldimethylsulfoxide | | |
| | (0.4/0.4/0/2) | | |
| Comparative | Dimethoxyethane/1,3- | | |
| Example 3 | dioxolane/sulforane/ | 21.0 | 1.85 |
| | dimethylsulfoxide (0.6/0.2/0.1/0.1) | | |
| Comparative | 1,3-Dioxolaneldiglyme (0.85/0.15) | 21.1 | 1.85 |
| Example 4 | | | |
| Comparative | 1,3-Dioxolane/diglyme | 20.7 | 1.97 |
| Example 5 | (0.05/0.95) | | |
| Comparative | Dimethoxyethane/ | 19.5 | 1.67 |
| Example 6 | 1,3-dioxolane (0.15/0.85) | | |
| Comparative | Dimethoxyethane/1,3-dioxolane | 22.3 | 1.86 |
| Example 7 | (0.95/0.05) | | |
| Comparative | Dimethoxyethane/1,3-dioxolane | 23.1 | 1.90 |
| Example 8 | (0.8/0.2) | | |
| Comparative | Dimethoxyethane | 21.5 | 1.86 |
| Example 9 | | | |
| Comparative | 1,3-Dioxolane | 18.1 | 1.72 |
| Example 10 | | | |
| Comparative | Diglyme | 21.2 | 1.91 |
| Example 11 | | | |

As shown in Table 1, the cells according to Examples 1 to 5 exhibited higher capacity than the cells according to Comparative Examples 1 to 11. In addition, the cells according to Examples 1 to 5 exhibited higher mid-voltage than the cells according to Comparative Examples 4, 7, and 8 to 11. The cell according to Comparative Example 5 exhibited good mid-voltage of 1.97 V, but low discharge capacity.

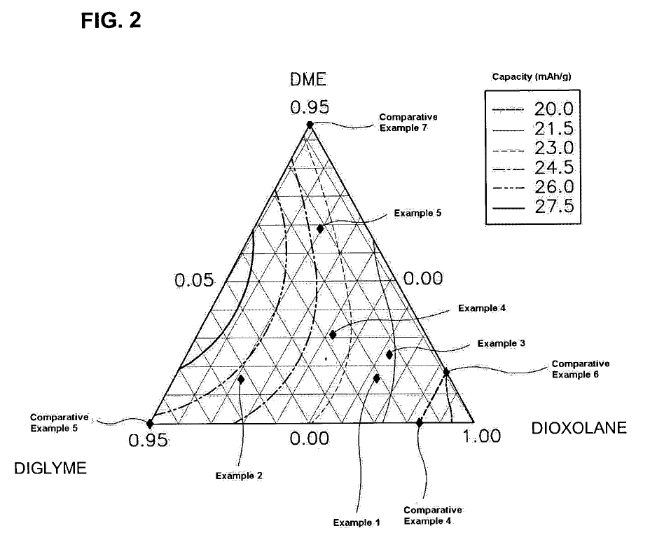

FIG. 2 shows a graph illustrating results, analyzed using the MINI-TAB program, of discharge capacity at the fifth cycle of the cells according to Examples 1 to 5 and Comparative Examples 4 to 6. It was evident from FIG. 2 that as the amount of dioxolane decreases, the discharge capacity decreases.

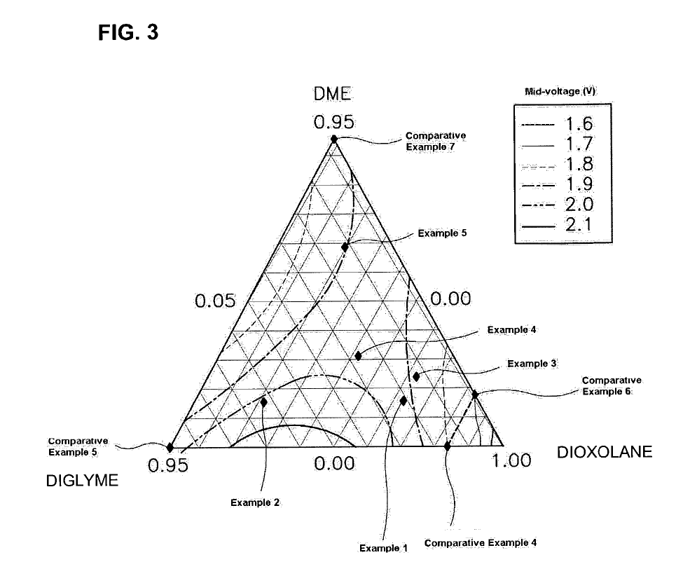

FIG. 3 showing mid-voltage at the fifth cycle of the cells according to Examples 1 to 5 and Comparative Examples 4 to 6, indicates that mid-voltage is high at the lower amount of dimethoxyethane.

As described above, the lithium-sulfur battery of the present invention exhibits high capacity and improved high-rate characteristics.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrolyte for a lithium-sulfur battery comprising:
organic solvents comprising dimethoxyethane, dioxolane, and diglyme; and
an electrolytic salt.

2. The electrolyte of claim 1, wherein the mixing ratio of dimethoxyethane, dioxolane, and diglyme is 10 to 70:5 to 70:10 to 70 by volume.

3. The electrolyte of claim 2, wherein the mixing ratio of dimethoxyethane, dioxolane, and diglyme is 20 to 60:10 to 40:30 to 70 by volume.

4. The electrolyte of claim 1, wherein the electrolytic salt is a salt including a lithium cation or a salt including an organic cation.

5. The electrolyte of claim 1, wherein the salt including a lithium cation is selected from the group consisting of lithium bis(fluoroalkylsulfonyl)imide, lithium triflate and LiPF₆.

6. The electrolyte of claim 5, wherein the lithium bis(fluoroalkylsulfonyl)imide is selected from the group consisting of lithium bis(trifluoromethylsulfonyl)imide (LiN(CF₃SO₂)₂), lithium bis(perfluoroethylsulfonyl)imide (LiN(C₂F₅SO₂)₂), and a mixture thereof.

7. The electrolyte of claim 4, wherein the salt including an organic cation is present in a liquid state at working temperatures at or below 100° C.

8. The electrolyte of claim 7, wherein the salt including an organic cation is selected from the group consisting of 1-ethyl-3-methylimidazolium bis(perfluoroethylsulfonyl)imide, 1butyl-3-methylimidazolium hexafluorophosphate, and a mixture thereof.

9. An electrolyte for a lithium-sulfur battery comprising:
organic solvents comprising 10 to 70 volume % of dimethoxyethane, 5 to 70 volume % of dioxolane, and 10 to 70 volume % of diglyme; and
an electrolytic salt.

10. The electrolyte of claim 9, wherein the mixing ratio of dimethoxyethane, dioxolane and diglyme is 20 to 60:10 to 40:30 to 70 by volume.

11. The electrolyte of claim 9, wherein the electrolytic salt is a salt including a lithium cation or a salt including an organic cation.

12. The electrolyte of claim 11, wherein the salt including a lithium cation is selected from the group consisting of lithium bis(fluoroalkylsulfonyl)imide, lithium triflate, and LiPF₆.

13. The electrolyte of claim 12, wherein the lithium bis(fluoroalkylsulfonyl)imide is selected from the group consisting of lithium bis(trifluoromethylsulfonyl)imide (LiN(CF₃SO₂)₂), lithium bis(perfluoroethylsulfonyl)imide (LiN(C₂F₅SO₂)₂), and a mixture thereof.

14. The electrolyte of claim 11, wherein the salt including an organic cation is present in a liquid state at working temperatures at or below 100° C.

15. The electrolyte of claim 14, wherein the salt including an organic cation is selected from the group consisting of 1-ethyl-3-methylimidazolium bis(perfluoroethylsulfonyl)imide, 1-butyl-3-methylimidazolium hexafluorophosphate, and a mixture thereof.

16. An electrolyte for a lithium-sulfur battery comprising:
organic solvents comprising dimethoxyethane, dioxolane, and diglyme; and
an electrolytic salt comprising lithium bis(fluoroalkylsulfonyl)imide.

17. The electrolyte of claim 16, wherein the mixing ratio of dimethoxyethane, dioxolane and diglyme is 10 to 70:5 to 70:10 to 70 by volume.

18. The electrolyte of claim 17, wherein the mixing ratio of dimethoxyethane, dioxolane and diglyme is 20 to 60:10 to 40:30 to 70 by volume.

19. The electrolyte of claim 5, wherein the lithium bis(fluoroalkylsulfonyl)imide is selected from the group consisting of lithium bis(trifluoromethylsulfonyl)imide (LiN(CF₃SO₂)₂), lithium bis(perfluoroethylsulfonyl)imide (LiN(C₂F₅SO₂)₂), and a mixture thereof.

20. A lithium-sulfur battery comprising:
a positive electrode comprising at least one positive active material selected from the group consisting of elemental sulfur, sulfur-based compounds, and a mixture thereof;
a negative electrode comprising a negative active material selected from the group consisting of a material to reversibly intercalate or deintercalate lithium ions, a material which reacts with lithium ions to prepare a lithium-included compound, a lithium metal, and a lithium alloy; and
an electrolyte comprising organic solvents and an electrolytic salt, the organic solvents comprising dimethoxyethane, dioxolane and diglyme.

21. The lithium-sulfur battery of claim 20, wherein the mixing ratio of dimethoxyethane, dioxolane and diglyme is 10 to 70:5 to 70:10 to 70 by volume.

22. The lithium-sulfur battery of claim 21, wherein the mixing ratio of dimethoxyethane, dioxolane and diglyme is 20 to 60:10 to 40:30 to 70 by volume.

23. The lithium-sulfur battery of claim 20, wherein the electrolytic salt is a salt including a lithium cation or a salt including an organic cation.

24. The lithium-sulfur battery of claim 23, wherein the salt including a lithium cation is selected from the group consisting of lithium bis(fluoroalkylsulfonyl)imide, lithium triflate, and LiPF₆.

25. The lithium-sulfur battery of claim 23, wherein the lithium bis(fluoroalkylsulfonyl)imide is selected from the group consisting of lithium bis(trifluoromethylsulfonyl)imide (LiN(CF₃SO₂)₂), lithium bis(perfluoroethylsulfonyl)imide (LiN(C₂F₅SO₂)₂), and a mixture thereof.

26. The lithium-sulfur battery of claim 23, wherein the salt including an organic cation is present in a liquid state at working temperatures at or below 100° C.

27. The lithium-sulfur battery of claim 26, wherein the salt including an organic cation is selected from the group consisting of 1-ethyl-3-methylimidazolium bis(perfluoroethylsulfonyl)imide, 1-butyl-3-methylimidazolium hexafluorophosphate, and a mixture thereof.

28. The lithium-sulfur battery according to claim 20, wherein the positive active material is elemental sulfur or at least one sulfur-based compound selected from the group consisting of Li₂Sₙ (n≧1), Li₂Sₙ (n≧1) dissolved in catholyte, organosulfur compounds, and carbon-sulfur polymers ((C₂Sₓ)ₙ: x=2.5 to 50, n≧2).

29. The lithium-sulfur battery of claim 20, wherein the positive electrode further comprises at least one additive selected from the group consisting of a transition metal, a Group IIIA element, a Group IVA element, a sulfur compound thereof, and alloys thereof.

30. The lithium-sulfur battery of claim 29, wherein the transition metal is at least one selected from the group consisting of Sc, Ti, V, Cr, Mn, Fe, Co, Ni, Cu, Zn, Y, Zr, Nb, Mo, Tc, Ru, Rh, Pd, AG, Cd, Ta, W, Re, Os, Ir, Pt, Au and Hg;
the Group IIIA elements include at least one of Al, Ga, In and Tl, and
the Group IVA elements include at least one of Si, Ge, Sn and Pb.
